(19) United States
(12) Patent Application Publication
(10) Pub. No.: US 2017/0018028 A1
(43) Pub. Date: Jan. 19, 2017

(54) SYSTEM AND METHOD FOR PROVIDING BEHAVIOR-BASED CREDIT AVAILABILITY

(71) Applicants: Christopher Gatz, Herndon, VA (US); Lawrence Kevin Jenkins, Richmond, VA (US)

(72) Inventors: Christopher Gatz, Herndon, VA (US); Lawrence Kevin Jenkins, Richmond, VA (US)

(73) Assignee: Capital One Financial Corporation, McLean, VA (US)

(21) Appl. No.: 12/855,398

(22) Filed: Aug. 12, 2010

(51) Int. Cl. G06Q 40/00

(52) U.S. Cl. CPC G06Q 40/025

(57) ABSTRACT

A system and method for providing behavior-based credit availability is presented. The described systems and methods may allow for a financial institution to raise a customer's credit line access beyond an initial amount without re-checking a customer's ability to pay. To this end, a customer may be pre-qualified for a credit limit up to a certain amount, but be granted line access to only a portion of that amount. If pre-established behavioral requirements are met, the customer may then receive line access to more of the pre-qualified line of credit, up to the full amount of the pre-qualified credit limit.

### FIELD OF THE DISCLOSURE

The present invention relates to a system and method for providing behavior-based credit availability.

### BACKGROUND OF THE DISCLOSURE

Financial institutions may be required to pre-qualify customers for a line of credit by checking each customer's “ability to pay.” The “ability to pay” analysis can include gathering customer income and debt information, often from one or more credit bureaus and from applicant supplied info. Once a customer is pre-qualified for a line of credit, the amount of the credit limit is extended to the customer. If, after a certain period of time, the customer or the financial institution desires to raise the line of credit beyond the pre-qualified amount, the financial institution must repeat the “ability to pay” analysis, including re-gathering customer income and debt information. Consequently, the process for increasing the amount of a customer's line of credit is expensive and time-consuming for the financial institution. These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 is a schematic diagram illustrating a system for providing access to behavior-based credit over a network, in accordance with an exemplary embodiment;

FIG. 2 depicts a block diagram of a computer system for providing behavior-based credit availability, in accordance with an exemplary embodiment;

FIG. 3 depicts a block diagram of a computer system for processing customer information, in accordance with an exemplary embodiment;

FIG. 4 depicts a flowchart for a method of gathering customer information, in accordance with an exemplary embodiment; and

FIG. 5 depicts a flowchart for a method of providing access to behavior-based credit, in accordance with an exemplary embodiment.

### DETAILED DESCRIPTION OF THE EMBODIMENTS

The following description is intended to convey a thorough understanding of the embodiments described by providing a number of specific exemplary embodiments and details involving systems and methods for providing line-access based on the satisfaction of behavior requirements. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

According to the various embodiments of the present disclosure, a financial institution may determine a pre-qualified credit limit for a customer based on customer information. The customer may be notified of the pre-qualified credit limit, but may only be granted line access to amount that is less than the full pre-qualified limit. The financial institution may then condition obtaining additional line access, up to the amount of the pre-qualified credit limit available to the customer, on a variety of conditions, such as the customer meeting pre-established behavior requirements. By way of a non-limiting example, customer behavior requirements may include requiring the customer to make on-time payments over a period of time, requiring the customer to maintain a certain income-to-debt ratio, or requiring that the customer not exceed a certain credit limit. If the behavior, or other conditional, requirements are met, the customer may be granted line access to the full amount of the pre-qualified credit limit or an amount that is more than the initial line access amount, but less than the full amount of the pre-qualified credit limit.

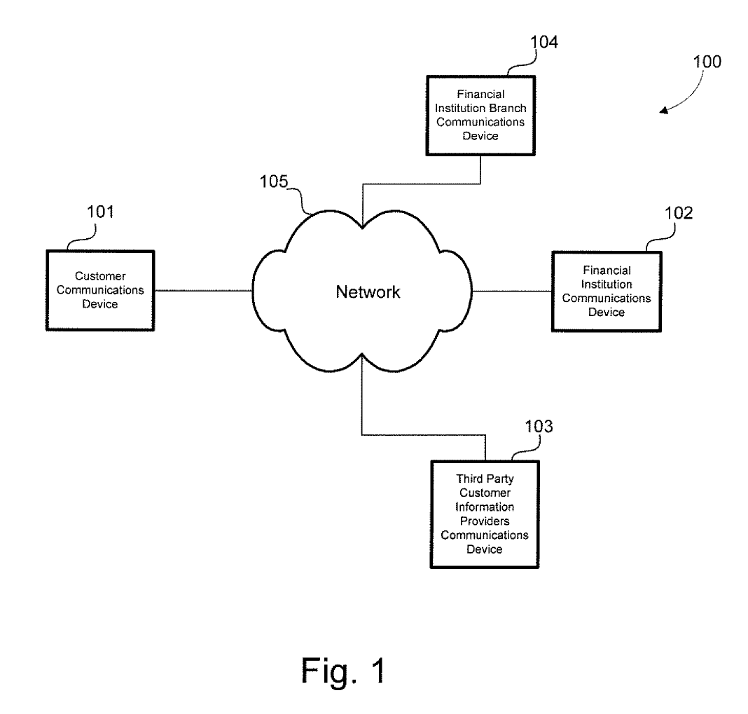

FIG. 1 is a schematic diagram illustrating a system 100 for extending credit to a customer, in accordance with an exemplary embodiment. As illustrated, system 100 may include one or more networks, such as network 105. Network 105 may be one or more of a wireless network, a wired network or any combination of wireless network and wired network. For example, network 105 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 105 may include, without limitation, telephone lines, fiber optics, IEEE Ethernet 902.3, a wide area network (“WAN”), a local area network (“LAN”), or a global network such as the Internet. Also network 105 may support an Internet network, a wireless communication network, a cellular network, or the like, or any combination thereof. Network 105 may further include one network, or any number of the exemplary types of networks mentioned above, operating as a stand-alone network or in cooperation with each other. Network 105 may utilize one or more protocols of one or more network elements to which they are communicatively coupled. Network 105 may translate to or from other protocols to one or more protocols of network devices. Although network 105 is depicted as a single network, it should be appreciated that according to one or more embodiments, network 105 may comprise a plurality of interconnected networks, such as, for example, the Internet, a service provider's network, a cable television network, corporate networks, and home networks.

Customers may access network 105 through one or more customer communications devices 101 that may be communicatively coupled to network 105. A financial institution may access network 105 through one or more financial institution communications devices 102 that may be communicatively coupled to network 105. A financial institution branch 104 may access network 105 through one or more financial institution branch communications devices that may be communicatively coupled to network 105. Third party customer information providers may access network 105 through one or more third party communication devices 103 that may be communicatively coupled to network 105. Communication devices 101, 102, 103, and 104 may include, for example, wireless phones, Personal Digital Assistants (PDA), desktop computers, laptop computers, servers, other computers or any combination thereof.

Customer communications devices 101, financial institution communications devices 102, financial institution branches communications devices 104, and third party customer information providers communications devices 103 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiple Access (CDMA) based systems suitable for transmitting and receiving data. Data may be transmitted and received wirelessly or may utilize cabled network connection or telecom connections, fiber connections, traditional phone wireline connection, a cable connection or other wired network connection.

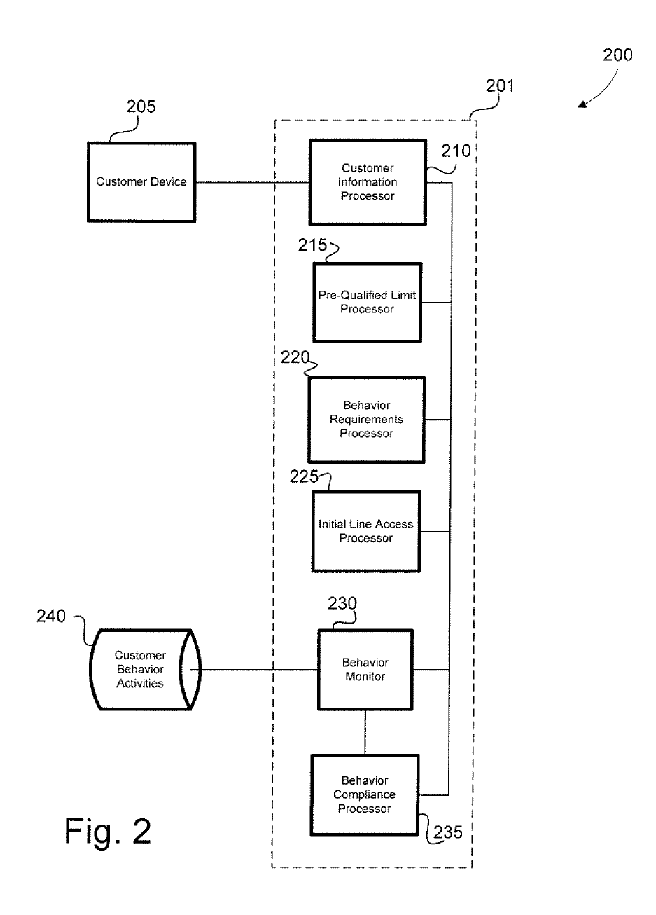

FIG. 2 depicts a block diagram of hardware processors, monitors, and devices or any combination thereof for providing behavior based credit availability, in accordance with an exemplary embodiment. As illustrated, the system 200 may include one or more systems, such as financial institution system 201. Financial institution system 201 may include a customer information processor 210, a pre-qualified limit processor 215, a behavior requirements processor 220, an initial line access processor 225, a behavior monitor 230 and a behavior requirements processor 235. According to various embodiments of the present disclosure, any of the processors, monitors, devices or other functions of the invention may exist either inside or outside of financial institution system 201. Financial institution system 201 may be connected by a wide area network (WAN), a local area network (LAN), a global network such as the Internet, a telephone network such as a public switch telephone network, a wireless communications network, a cellular network, an intranet, or the like, or any combination thereof. In exemplary embodiments of the disclosure, the system 200 may include one, or any number of exemplary types of above-described networks operating as a stand-alone network or in cooperation with each other. In exemplary embodiments of the disclosure, the system may include one, or any number of exemplary types of above described systems operating as a stand-alone system or in cooperation with each other.

According to the various embodiments of the present disclosure, customer information processor 210 may receive customer application data from customer device 205. Customer device 205 may be a mobile phone, a Personal Digital Assistant (FDA), a laptop computer or any other like electronic device. Customer application data may include any customer information associated with a credit application, including income-to-debt ratio, employment status, customer name, customer address, customer social security number, customer date of birth, or any other customer application information relevant to extending a line of credit to the customer.

Customer information processor 210 may receive customer application data 205 from any number of sources, including from a customer, a financial institution branch, third-party information providers, other data sources within financial institution system 201, credit bureaus, or from any other data source that may be accessible to customer information processor 210 over any number of systems or networks, including the Internet. Further, customer information processor 210 may receive customer application information that may be accessible to customer information processor 210 over the financial institution system 201, for example information related to an earlier or existing relationship with a customer. Customer information processor 210 may include one or more modules for recording, transmitting, receiving, and storing data. Data processed by customer information processor 210 may be received by a pre-qualified limit processor 215, a behavior requirements processor 220, and/or an initial line access processor 225.

Pre-qualified limit processor 215 may receive data from customer information processor 210 to determine a pre-qualified credit limit for the customer. Pre-qualified limit processor 215 may include one or more modules for recording, receiving, storing and analyzing data (not shown). Pre-qualified limit processor 215 may be configured to determine a pre-qualified limit in any number of ways, including without limitation, according to financial institution credit policies, according to common industry standards, according to federal guidelines or requirements, or any combination thereof. Pre-qualified credit limit processor 225 may also include one or more modules for establishing an account associated with the pre-qualified credit limit for the customer.

Behavior requirements processor 220 may receive data from customer information processor 210 and use that information to determine behavior requirements to make more credit available for the customer. Behavior requirements processor 220 may include one or more modules for recording, receiving, storing and analyzing data. Behavior requirements processor 220 may be configured to determine customer behavior requirements to make more credit available in any number of ways, including without limitation, according to financial institution policies, according to common industry standards, according to federal guidelines or requirements, or any combination thereof. Behavior requirements processor 220 may establish a period of time wherein the customer is eligible to access more of the line of credit or may establish a period of time wherein the customer must demonstrate continuous compliance with the behavior requirements. Behavior requirements processor 220 may also establish that the customer will not be entitled to remain enrolled in the program after a finite period of time. Also, behavior requirements processor 220 may permit the customer to remain enrolled for an unspecified period of time.

Initial line access processor 225 may receive data from customer information processor 210 to determine an amount of the total pre-qualified credit limit that the customer will have access to. Initial line access processor 225 may include one or more modules for recording, receiving, storing and analyzing data. Initial line access processor 225 may be configured to determine an initial line of accessible credit in any number of ways, including without limitation, according to financial institution policies, according to common industry standards, or according to federal guidelines or requirements. Initial line access processor 225 may also include one or more modules for establishing an account associated with the pre-qualified credit limit for the customer.

By way of a non-limiting example, a financial institution may pre-qualify a customer for a credit limit of $1,000. However, the customer may only be granted line access to $500 of the total pre-qualified line of $1,000. The financial institution may establish behavior requirements, such as requiring on-time payments over a six-month period, for the customer to obtain line access to $750 of the total pre-qualified line of $1,000. If the customer meets the initial behavior requirements, the financial institution may establish additional behavior requirements for the customer to obtain line access to the full pre-qualified credit limit of $1,000.

In another non-limiting example, a financial institution may pre-qualify a customer for a credit limit of $1,000. The customer may only be granted line access to $500 of the total pre-qualified line of $1,000. The financial institution may establish behavior requirements, such as maintaining a certain income-to-debt ratio for a six month period, for the customer to obtain line access to the full pre-qualified credit limit of $1,000.

Each of the processors 215, 220, and 225 may utilize the processed customer information to notify the customer of the total pre-qualified amount, the behavior requirements, and the initial line of available credit. The customer may be notified in any number of ways, including by mail, e-mail, text message, telephone, in-person or through any customer device, such as customer device 205. Each of the processors 215, 220, and 225 may be network accessible storage and may be local, remote, or a combination thereof in relation to financial system 201.

Customer behavior activities 240 may be monitored by behavior monitor 230. Customer behavior monitor 230 may include one or more modules (not shown) for processing, recording, transmitting, receiving, and storing customer behavior activities 240. Customer behavior activities 240 may include, customer income to-debt ratio, customer payment history associated with accounts both inside and outside financial institution system 201, customer employment status, customer purchasing history, customer purchasing patterns, customer information obtained from credit bureaus, or any other customer behavior activities 240 that may be accessible to behavior monitor 230 over one or more networks, such as the Internet. Customer behavior monitor 230 may be communicatively linked to any number of customer activities sources, including without limitation, customer bank accounts and/or customer credit card accounts held both inside and outside of financial institution system 201.

Customer behavior activities data obtained by behavior monitor 230 may be routed to behavior assessment processor 235. The behavior monitor 230 and the behavior assessment processor 235 may be network accessible storage and may be local, remote, or a combination thereof to the financial institution network 201. The behavior monitor 230 and the behavior assessment processor 235 may utilize a tape, disk, storage area network, an internet small computer systems interface, a common internet file system, network attached storage, a network file system, or other computer accessible storage. In one or more embodiments, the behavior monitor 230 may be a database, such as an Oracle database, a Microsoft SQL Server database, a DB2 database, a MySQL database, a Sybase database, an object oriented database, a hierarchical database, or other database.

Behavior assessment processor 235 may store, aggregate, process or compile customer behavior activities 240 data received from the behavior monitor 230 to compare customer behavior to customer behavior requirements created by behavior requirements processor 220. Behavior assessment processor 235 may interpret whether the customer is entitled to access a greater portion of the line of credit in accordance with the customer behavior requirements established by behavior requirements processor 220 and customer behavior monitored by behavior monitor 235. Behavior assessment processor 235 may analyze customer behavior data and provide the customer with line access to more of the pre-qualified credit limit. Behavior assessment processor 235 may also analyze customer behavior data and deny the customer line access to more of the pre-qualified credit limit. In an exemplary embodiment, behavior assessment processor 235 may determine that the customer has not met the behavior requirements within the time-frame established by behavior requirements processor 220 and may affect the customer's credit limit accordingly. For example, the customer may be denied line access to more of the pre-qualified line of credit indefinitely, the customer's line access may be decreased or the customer may be denied line access to more of the pre-qualified line of credit for a period of time.

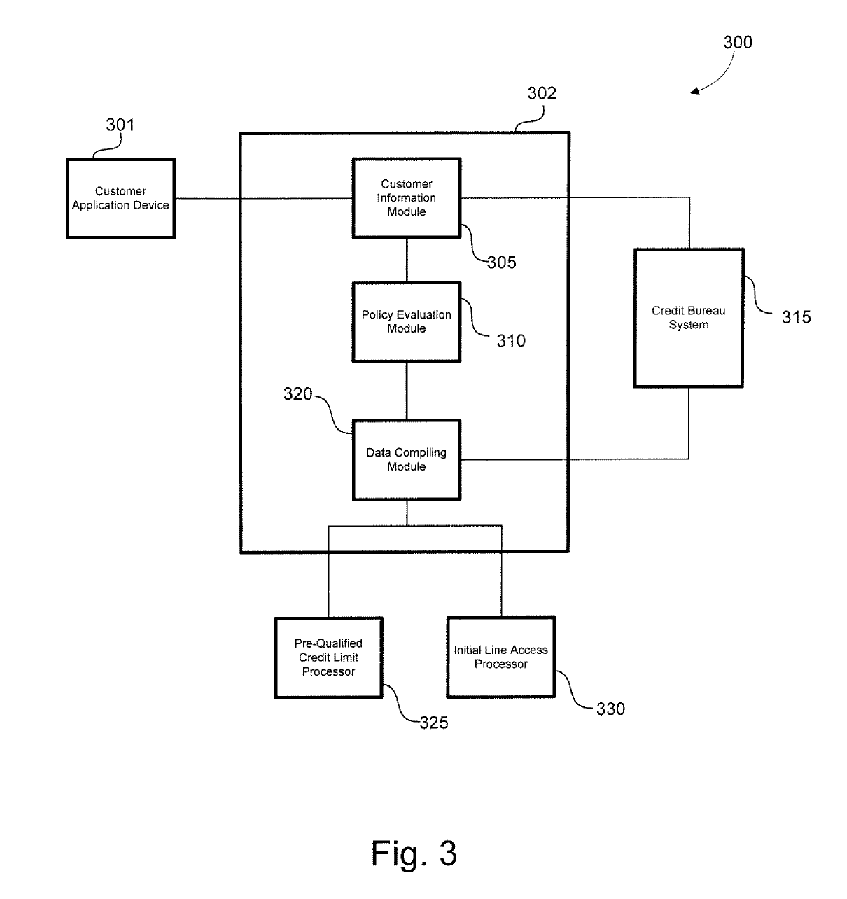

FIG. 3 depicts a block diagram of hardware processors, monitors, modules and networks, for processing customer information in accordance with an exemplary embodiment. As illustrated, the system 300 may include one or more processors, such as customer information processor 302. Customer information processor 302 may be similar to customer information processor 210 as discussed in FIG. 2. As illustrated, the customer information processor 302 may contain one or more components including a customer information module 305, a policy evaluation module 310, and a data compiling module 320. The modules may reside on the same physical system, or may reside on more than one physical system, and may be in communication with each other in any number of ways, including over a network such as the Internet. The modules may be distinct and may be in communication with each other, or functions of the modules may be embodied in a combination of the modules.

The customer information module 305 may receive customer application data from customer device 301, or from any number of sources, including sources located over a network, such as the Internet. Customer device 301 may be similar to customer device 205 as depicted in FIG. 2. Credit application data may be stored by the customer information module 305 in any electronic format. Customer information module 305 may assign tasks to other modules and may keep track of the tasks that have been completed and the tasks that need to be performed. For example, the customer information module 305 may assign one or more policy evaluation modules 310 the task of evaluating customer application data according to internal risk management models. Customer information module 305 may also request customer credit information from a credit bureau system 315. A credit bureau system may be communicatively coupled to customer information processor 302 in any number of ways, including across a network, such as the Internet. Information requested from a credit bureau system 315 may include, income-to-debt ratio, credit history or any other customer information.

Policy evaluation module 310 may process customer information according to financial institution risk management models. Policy evaluation module 310 may also process customer information according to data obtained from a prior or existing relationship with the customer. Data compiling module 320 may compile information related to customer information obtained from one or more credit bureaus 315 and one or more policy evaluation modules 310. Customer information module 305, policy evaluation module 310, and data compiling module 320 may reside internally or externally within the customer information processor 302, The modules 305, 310, and 320 may reside and execute on a single device or on separate devices. The pre-qualified credit limit processor 325 and the initial line access processor 330 may receive data from data compiling module 320. The pre-qualified credit limit processor 325 may be similar to the pre-qualified credit limit processor 215 as described in FIG. 2. The initial line access processor 330 may be similar to the initial line access processor 225 as described in FIG. 2.

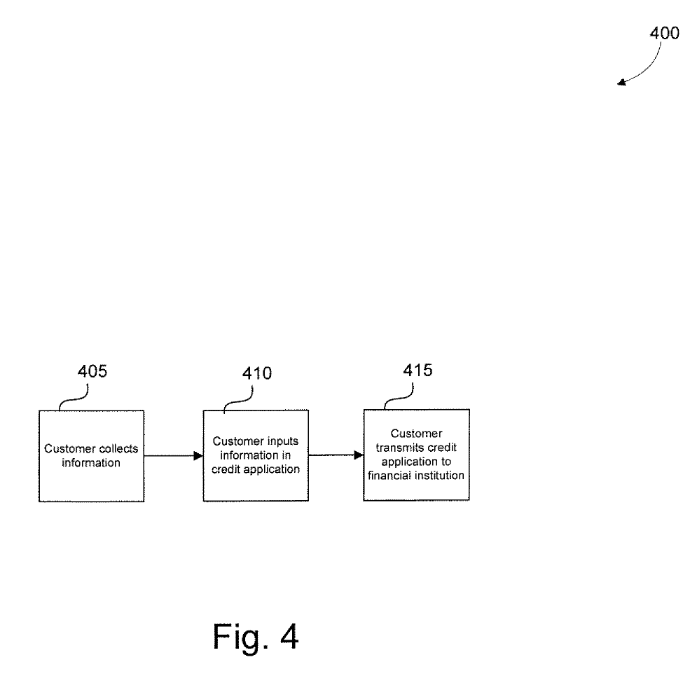

FIG. 4 depicts a flowchart for a method 400 of transmitting customer data to a financial institution. In box 405 a customer collects information to be included on a credit application. Information that may be included on a credit application may include, for example, customer employment status, customer references, customer personal information, customer address, customer date of birth, customer social security number, customer credit history, customer annual income information, customer debt information, customer income-to-debt ratio, customer authorization to retrieve customer information from credit bureaus, whether customer is a home owner or a renter, customer monthly housing payments and any other information that may be included on a credit application.

In box 410, the customer may input the credit information onto a credit application form. A credit application may be in any form, including, an electronic form residing on a financial institution network server, an electronic form residing on a computer, an electronic form accessible via email, and an electronic form accessible via a mobile phone, a Personal Digital Assistant (PDA), a laptop computer or any other electronic device.

In box 415, the customer transmits the credit application to the financial institution. The customer may transmit the credit application to the financial institution over a network, such as the Internet. The customer may also transmit the credit application via a mobile phone, a Personal Digital Assistant (PDA), a laptop computer or any other electronic device. A financial institution may receive the data in any number of ways, including over a network such as the Internet. The information may be received by a mobile phone, a financial institution server, a computer, or any other device. Customer application data may be stored and processed by a financial institution in any number of ways.

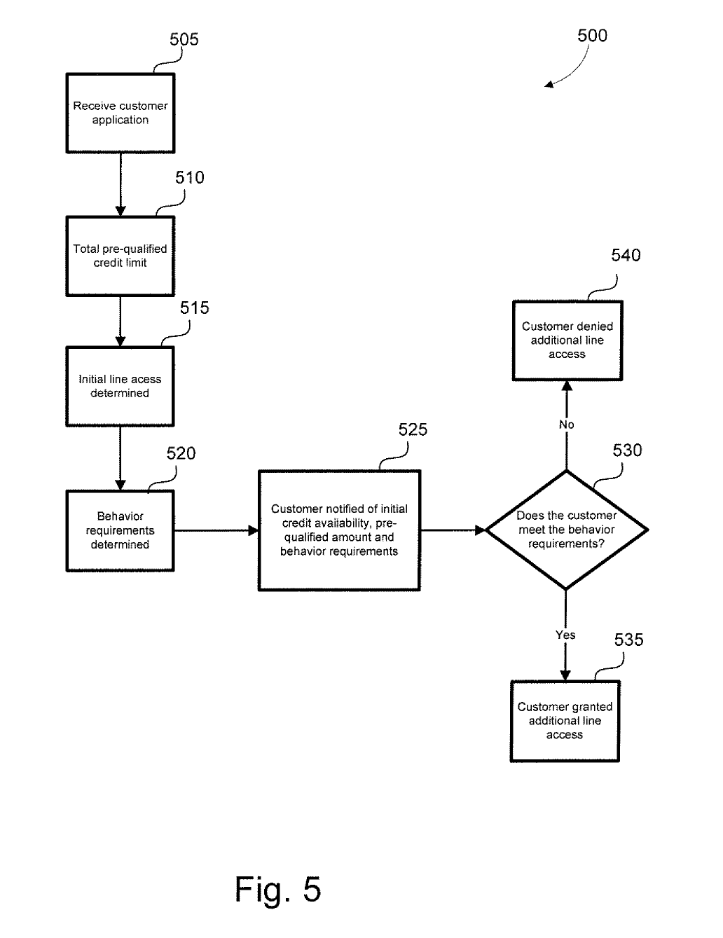

FIG. 5 depicts a flowchart for a method 500 of providing a line access increase to a customer, in accordance with an exemplary embodiment. In box 505, a financial institution may receive customer application data. Customer application data may be received from any number of sources through communications devices coupled to a network, such as the Internet. Processors, such as the processors depicted in FIG. 2, may be provided to facilitate the receipt, storage, processing or routing of customer application data. Customer application data may also be received by any of the methods as depicted in FIG. 4 or by any other method well understood in the art.

In box 510, a financial institution may pre-qualify the customer for a credit limit. A financial institution may compile and analyze customer data obtained from the customer application, credit bureaus, prior or existing relationships between the customer and the financial institution or from other sources, including third-party sources. Processors, such as the processors depicted in FIG. 2, may be provided to facilitate the receipt, storage, processing, routing and analysis of customer application data to pre-qualify the customer for a line of credit. Customer data may include information relating to customer income-to-debt ratio, customer employment information, customer credit history or any other information that may be relevant to pre-qualify a customer for a credit limit. The amount of the pre-qualified credit limit may be determined in any number of ways, including without limitation, according to financial institution policies, according to common industry standards, or according to federal guidelines or requirements.

In box 515, a financial institution may determine an initial line access amount for the customer. The amount of the initial line access may be less than the amount of the pre-qualified credit limit. A financial institution may compile and analyze customer data obtained from the customer application, credit bureaus, prior or existing relationships between the customer and the financial institution or from other sources, including third-party sources. Processors, such as the processors depicted in FIG. 2, may be provided to facilitate the receipt, storage, processing, routing and analysis of customer data to establish an initial line access amount. Customer data may include information relating to customer income-to-debt ratio, customer employment information, customer credit history or any other information that may be relevant to establish an initial line access amount. The amount of the initial line access amount may be determined in any number of ways, including according to financial institution policies, according to common industry standards, according to federal guidelines or requirements, according to the amount of the pre-qualified line of credit, or according to any other information that may be relevant to make such a determination.

As depicted in box 520, a financial institution, for example, may establish customer behavior requirements. A financial institution may compile and analyze customer data obtained from the customer application, credit bureaus, prior or existing relationships between the customer and the financial institution or from other sources, including third-party sources. Processors, such as the processors depicted in FIG. 2, may be provided to facilitate the receipt, storage, processing, routing and analysis of customer data to establish customer behavior requirements. Customer data may include information relating to customer income-to-debt ratio, customer employment information, customer credit history or any other information that may be relevant to establish customer behavior requirements. The customer behavior requirements may be determined in any number of ways, including, without limitation, according to financial institution policies. The customer behavior requirements may pre-establish the requirements for the customer to obtain line access beyond the initial line access amount, but less than the full amount of the pre-qualified credit limit. Further, the customer behavior requirements may pre-establish the requirements for the customer to obtain line access up to the full amount of the pre-qualified credit limit. Customer behavior requirements may include, for example, requiring that the customer make on-time payments over a period of time. Customer behavior requirements may also include requiring that the customer maintain a certain income-to-debt ratio or requiring that the customer's purchasing patterns comply with financial institution policies. In an exemplary embodiment, customer behavior requirements may establish a time frame in which the customer may obtain access to the total pre-qualified line of credit.

As depicted in box 525, a customer may be notified of the total pre-qualified credit limit 510, extended the initial line access amount 515, and informed of the behavior requirements to receive additional line access 520. The customer may be notified in any number of ways, including in person, by mail, or by a communications device coupled to one or any number of networks, such as the Internet. Processors, such as the processors depicted in FIG. 2, may be provided to facilitate the receipt, storage, processing or routing of data to notify the customer of the total pre-qualified line 510, to facilitate the receipt, storage, processing or routing of data to extend the initial line of credit 515, and to facilitate the receipt, storage, processing or routing of data to notify the customer of the behavior requirements 520.

As depicted in box 530, a financial institution may determine whether a customer has met the behavior requirements. The financial institution may determine behavior compliance by monitoring customer behavior. Monitors, such as the monitor depicted in FIG. 2, may be provided to monitor customer behavior. Processors, such as the processors depicted in FIG. 2, may be provided to receive, store, process, route and analyze customer behavior. Behavior may be monitored from various information sources which may be communicatively coupled to any number of systems or networks, including the Internet. For example, behavior may be monitored in any number of ways from any number of information sources, including without limitation, by checking payment systems periodically, by receiving customer payment notifications periodically, by checking credit bureaus periodically, and/or by receiving customer account balance notifications periodically. If a customer has met the behavior requirements, processors, such as the processors depicted in FIG. 2, may be provided to grant the customer additional line access 535. Also, processors, such as the processors depicted in FIG. 2, may be provided to extend the customer line access up to the full amount of the pre-qualified credit limit. Further, if the behavior requirements have not been met, processors, such as the processors depicted in FIG. 2, may be provided to deny the customer additional line 540. This behavior requirements determination process may continue on until the customer has met the behavior requirements. In another exemplary embodiment, the behavior requirements determination process may end after a finite period of time has elapsed.

The description above describes user devices, an analysis system, a communication network having network elements that are coupled to each other via one or more links (e.g., physical or logical), various networks within a domain of the communication network, and other elements for coupling customer to the communication network, some of which are explicitly depicted, other of which are not. As used herein, the term “module” may be understood to refer to executable software, firmware, hardware, or various combination thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein maybe tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method comprising:
processing, using a computer processor associated with a financial institution, customer information and communicatively linked to customer data sources, the customer information including at least information about the income and debts of the customer, wherein the computer processor determines a pre-qualified credit limit for a customer based at least in part on the customer information;
creating, using the computer processor, an account for the customer, wherein the account is associated with the pre-qualified credit limit for the customer;
determining, using the computer processor, a first portion of the pre-qualified credit limit available to the customer account, the first portion of the pre-qualified credit limit being less than a full amount of the pre-qualified credit limit;
assigning, using the computer processor, behavior requirements to the account, wherein the behavior requirements are time-based goals for at least one of: the account and at least one other account associated with the customer;
automatically monitoring and routing, using the computer processor, activity associated with the account and the at least one other account associated with the customer to determine whether at least one customer account is meeting the behavior requirements, wherein monitoring comprises:
receiving, at the computer processor, customer behavior activity data associated with the customer account and the at least one other account associated with the customer, wherein customer behavior activity data comprises at least one of: income-to-debt ratio, account payment data, and purchase data posted to the account or the at least one other account;
recording, in data storage connectively coupled to the computer processor, the received customer behavior activity data; and
analyzing, using the computer processor, the recorded customer behavior activity data to determine whether the recorded customer behavior activity data meets the assigned behavior requirements; and
assigning, using the computer processor, a second portion of the pre-qualified credit limit available to the customer account based on a determination that one or more of the behavior requirements are met, wherein the second portion is greater than the first portion.

2. The method according to claim 1, further comprising:
receiving customer information comprising customer credit application information over a network.

3. The method according to claim 1, further comprising:
receiving customer information comprising customer credit application information from a mobile device.

4. The method according to claim 1, wherein the processing customer information further comprises obtaining customer information from a credit bureau.

5. The method according to claim 1, wherein the processing customer information further comprises using a credit policy.

6. The method according to claim 1, wherein the behavior requirements comprise:
a number of on-time payments over a period of time.

7. The method according to claim 1, wherein the behavior requirements comprise:
a period of time a customer maintains a certain income-to-debt ratio.

8. The method according to claim 1, wherein the behavior requirements comprise:
specific purchasing patterns.

9. The method according to claim 1, wherein the second portion of the pre-qualified credit limit is equal to the pre-qualified credit limit.

10. The method according to claim 1, further comprising:
communicating, from the processor via a network, the pre-qualified credit limit available to the customer;
communicating, from the processor via the network, the first portion of the pre-qualified limit made available to the customer;
communicating, from the processor via the network, the behavior requirements to the customer; and
notifying, from the processor via the network, the customer that if one or more behavior requirements is met, the second portion of the pre-qualified limit will be available to the customer.

11. The method according claim 1, further comprising:
establishing, using the processor a finite period of time in which the customer will be entitled to access the second portion of the pre-qualified credit limit.

12. A system comprising:
a qualification processor associated with a financial institution and communicatively linked to customer data sources that determines a pre-qualified credit limit for a customer using customer information, the customer information including at least information about the income and debts of the customer;
a database that stores an account associated with the pre-qualified credit limit for the customer;
an initial line access processor that determines a first portion of the pre-qualified credit limit available to the customer account, the first portion of the pre-qualified credit limit being less than a full amount of the pre-qualified limit;
a behavior requirements processor that assigns behavior requirements to the account, wherein the behavior requirements are time-based goals for at least one of: the account and at least one other account associated with the customer;
a monitoring processor that automatically monitors and routes activity associated with the account and the at least one other account associated with the customer to determine whether at least one customer account is meeting the behavior requirements, wherein monitoring comprises:
receiving, at the monitoring processor, customer behavior activity data associated with the customer account and the at least one other account associated with the customer, wherein customer behavior activity data comprises at least one of: income-to-debt ratio, account payment data, and purchase data posted to the account or the at least one other account;
recording, in database connectively coupled to the monitoring processor, the received customer behavior activity data; and
analyzing, using the monitoring processor, the recorded customer behavior activity data to determine whether the recorded customer behavior activity data meets the assigned behavior requirements; and
a credit limit processor that assigns a second portion of the pre-qualified credit limit available to the customer account based on the determination that the one or more behavior requirements are met, wherein the second portion is greater than the first portion.

13. The system of claim 12, wherein the determining processor further comprises a communications device coupled to a network to receive customer information from a credit bureau.

14. The system of claim 12, further comprising a communications device configured to receive a customer credit application.

15. The system of claim 14, where the communications device configured to receive a customer credit application is further configured to receive customer applications over a network.

16. The system of claim 14, where the communications device configured to receive a customer credit application is further configured to receive customer applications from a mobile device.

17. A non-transitory computer-accessible medium encoded with computer program code, that when executed, causes a processor to:
process customer information, the customer information including at least information about the income and debts of the customer, wherein processing customer information includes determining a pre-qualified credit limit for a customer based at least in part on the customer information;
create an account for the customer, wherein the account is associated with the pre-qualified limit for the customer;
determine a first portion of the prequalified credit limit available to the customer account, wherein the first portion is less than the pre-qualified credit limit;
assign behavior requirements to the account, wherein the behavior requirements are time-based goals for at least one of: the account and at least one other account associated with the customer;
automatically monitor and route activity associated with the account and the at least one other account associated with the customer to determine whether at least one customer account is meeting the behavior requirements, wherein monitoring comprises:
receiving customer behavior activity data associated with the customer account and the at least one other account associated with the customer, wherein customer behavior activity data comprises at least one of: income-to-debt ratio, account payment data, and purchase data posted to the account or the at least one other account;
recording, in data storage connectively coupled to the processor, the received customer behavior activity data; and
analyzing the recorded customer behavior activity data to determine whether the recorded customer behavior activity data meets the assigned behavior requirements; and
assigning a second portion of the pre-qualified credit limit available to the customer account based on the determination that one or more of the behavior requirements are met, wherein the second portion is greater than the first portion.
